(19) United States
(12) Patent Application Publication
(10) Pub. No.: US 2014/0111311 A1
(43) Pub. Date: Apr. 24, 2014

(54) METHOD AND APPARATUS FOR OPERATING AN RFID READER

(71) Applicant: SYMBOL TECHNOLOGIES, INC., HOLTSVILLE, NY (US)

(72) Inventors: MICHAEL J. KOCH, FT. SALONGA, NY (US); BENJAMIN J. BEKRITSKY, MODIN (IL); ALEXANDER M. JACQUES, KINGS PARK, NY (US); NEERAL SESHADRI, BANGALORE (IN)

(73) Assignee: SYMBOL TECHNOLOGIES, INC., HOLTSVILLE, NY (US)

(21) Appl. No.: 13/658,936

(22) Filed: Oct. 24, 2012

(51) Int. Cl. G06K 7/01

(52) U.S. Cl. 340/10.5

(57) ABSTRACT

A method and apparatus for operating an RFID scanner is provided herein. During operation, an RFID scanner will utilize beamforming techniques to appropriately beamform an interrogation signal. A first beamforming scheme will be used for a first task (e.g., EAS, inventory management, point-of-sale mode scanning of a first area, . . . , etc.) and a second beamforming scheme will be used for a second task.

### FIELD OF THE INVENTION

The present invention generally relates to a method and apparatus for operating an RFID reader, and more particularly to a method and apparatus for operating an RFID reader capable of beamforming an interrogation signal.

### BACKGROUND OF THE INVENTION

RFID systems and their basic operating principles are well known. RFID systems employ fixed (stationary) RFID readers and/or portable RFID readers, both of which can be used to interrogate RFID tags associated with products, containers, or any items of interest. A traditional RFID reader interrogates RFID tags, which respond by providing tag data that can be collected, interpreted, displayed, or otherwise processed by the RFID reader. In this regard, traditional RFID readers perform both interrogation and reading functions.

In practice, an RFID reader has a limited interrogation zone. Tags located within the interrogation zone can be adequately energized by the interrogation signals emitted by the RFID reader, and tags located outside the interrogation zone may not be properly energized and/or may not be able to produce a tag response signal having the minimum required signal strength needed for reading. These characteristics are illustrated in FIG. 1, which is a simplified diagram of a conventional RFID system 100 that includes a first RFID reader 102 and a second RFID reader 104. The first RFID reader 102 has a first coverage zone 106 associated therewith, and the second RFID reader 104 has a second coverage zone 108 associated therewith. Even though these two coverage zones 106, 108 overlap somewhat, at least some RFID tags 110 can only be read by the first RFID reader 102, because they are outside of the second coverage zone 108. In this respect, conventional RFID reader coverage is limited by the forward link (interrogation) range.

The interrogation range limitations mentioned above can be undesirable in certain situations. For example, if multiple readers are deployed for purposes of redundancy and/or for determining the location of tags (using, for example, triangulation techniques), then those readers must be densely arranged to ensure that their interrogation zones overlap by at least a minimum amount needed to support the particular application.

Additionally, the activities within a given coverage area often vary in nature. For example, part of the coverage area may be a store entrance/exit in a retail store that is monitored for theft of an item. An RFID reader that performs the functions of electronic article surveillance (EAS) will determine if an unpaid item exits the store with high accuracy and low latency. This same RFID reader may have an area of coverage that is much greater than the store entrance/exit.

In addition to EAS functionality, an RFID reader may also function to provide an inventory management function by identifying all of the items within its range and sending the item information to a host. Inventory management functions generally do not have critical latency requirements, and can be provided on an “as-needed” basis.

In order to implement an RFID system that cover a large area and employ different functions a large number of densely arranged readers are needed. This can be costly to implement, maintain, and operate. Such a prior-art system is shown in FIG. 2. For simplicity, only three RFID readers are shown. During operation, the three RFID readers will each perform a separate task, and monitor a separate area of the premises. For example RFID reader 1 may perform EAS functionality, while readers 2 and 3 will perform inventory management functions.

As is evident, prior art systems must employ multiple RFID readers to cover multiple areas and perform multiple functions. It would be beneficial to reduce the number of costly RFID readers and still retain the benefits of having many readers performing many functions.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a general operational environment, according to one embodiment of the present invention;

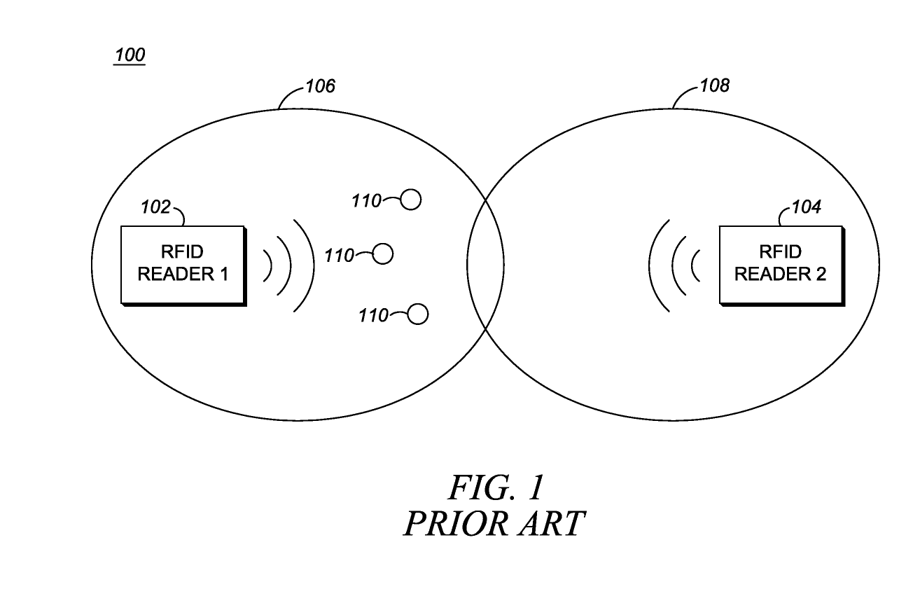

FIG. 2 illustrates prior art RFID readers employed within a premise, each covering a unique scan area and performing a unique task.

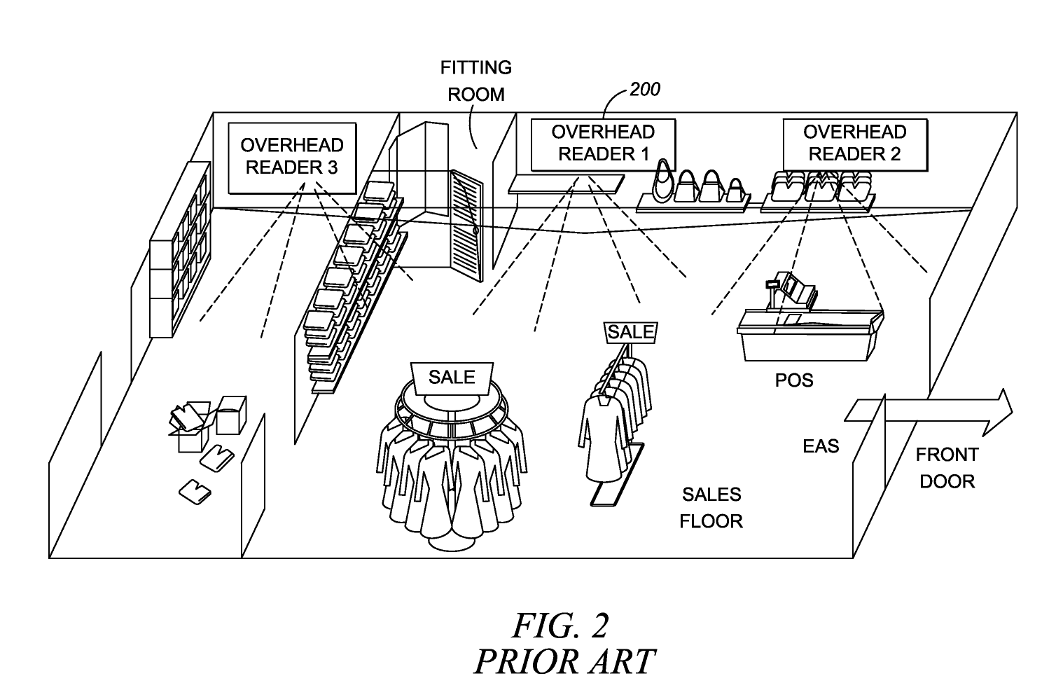

FIG. 3 is a block diagram of an RFID reader.

FIG. 4 is a block diagram of an RFID reader front end.

FIG. 5 illustrates an RFID reader employed within a premise scanning a first area with a first antenna pattern.

FIG. 6 illustrates an RFID reader employed within a premise scanning a second area with a second antenna pattern.

FIG. 7 illustrates the time-varying nature of the RFID reader of FIG. 5 and FIG. 6.

FIG. 8 is a flow chart showing operation of the RFID reader in FIG. 5 and FIG. 6.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for operating an RFID scanner (sometimes referred to as an RFID reader) is provided herein. During operation, an RFID scanner will utilize beamforming techniques to appropriately beamform an interrogation signal. A first beamforming scheme and/or operational parameter will be used for a first task (e.g., EAS, inventory management, point-of-sale mode scanning of a first area, . . . , etc.) and a second beamforming scheme and/or operational parameter will be used for a second task. There is no limit to the number of tasks that can be allocated via this method.

Due to the multiple capability of an RFID reader utilizing this method, a single reader will be able to provide wide areas of coverage for example, inventory control, while simultaneously being able to focus instantaneous coverage on a much smaller zone for example, point-of-sale scanning. A same physical reader may be used in a time-shared manner to provide “virtual RFID reader” functionality, switching between modes of operation based on a predetermined schedule.

The “virtual reader” capability allows the same physical reader to act as if it were multiple RFID readers with different properties and behaviors by sharing the available time according to the need of any higher-layer application.

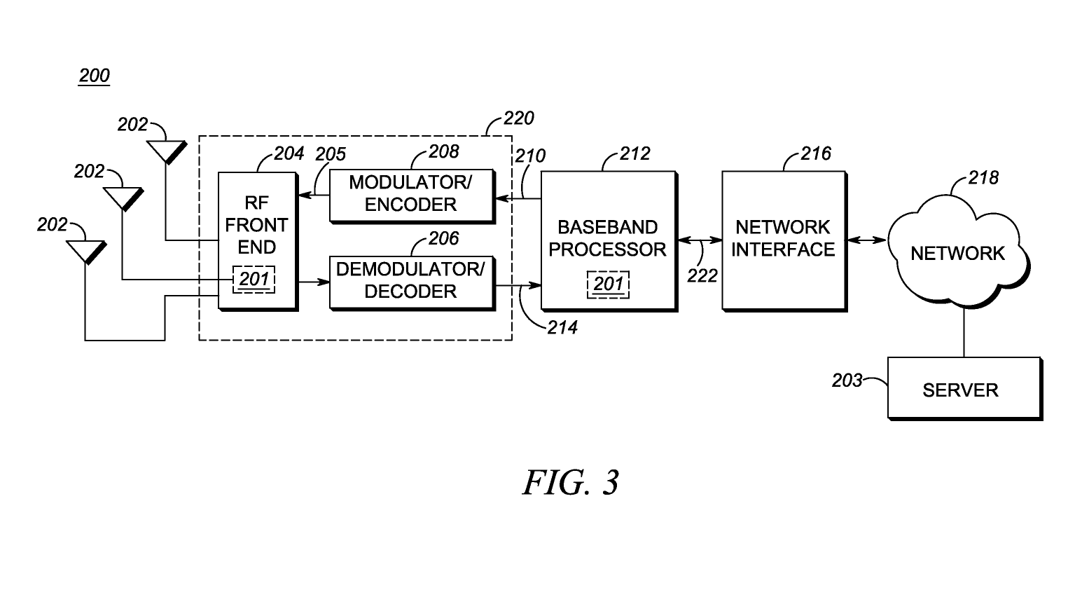

FIG. 3 is a block diagram of an RFID reader 200. Reader 200 is capable of different operational modes, each mode using differing operational parameters. Each mode requires certain transmission properties (operating parameters) of the signal processed by transceiver 220, for example the data rate or transmit power level of the RF signals, Other operational modes are possible and will be apparent to those familiar with wireless communication systems in general, and RFID Gen 2 embodiments in particular.

Reader 200 is utilized to read RFID tags used to mark, inventory and track various products. RFID tags generally transmit to reader 200 via a radio frequency (RF) signal that includes product or similar information. RFID tags generally include an integrated circuit for storing and processing information, a transceiver for transmitting and receiving RF signals, and an antenna. Some RFID tags are active RFID tags and include their own battery power source.

Passive RFID tags do not have their own power source and require receiving a power signal from reader 200 to operate. For interrogating passive RFID tags, reader 200 generally transmits a continuous wave (CW) or modulated RF signal to a tag. The tag receives the signal, and responds by modulating the signal and then “backscattering” an information response signal to reader 200. Reader 200 receives the response signal from the tag, and the response signal is demodulated, decoded and further processed.

Reader 200 employs transmit beamforming (sometimes referred to as transmit adaptive array (TXAA) transmission) to increases the effective signal seen by RFID tag by creating a coverage pattern that tends to be directional in nature (i.e., not uniformly broadcast). This is accomplished by employing multiple antennas 202 and having scheduler 201 weight each antenna 202 such that the combined transmissions result in a desired beamformed pattern. For example one pattern may result in a very focused beam for EAS operations, while another pattern may deliver a very wide-angled beam for inventory management purposes.

With the above in mind, a higher-layer application (in this case server 203) is equipped to determine an optimal schedule for operation of reader 200. In determining the optimal schedule, server 203 may, for example, determine time periods where reader 200 will employ various operational modes. This schedule is communicated to reader 200.

As shown in FIG. 3, scheduler 201 may be located within baseband processor 212 and/or located within RF front end 204. Regardless of where scheduler 201 is located, scheduler 201 servs to control RF front end and/or baseband processor to provide antenna weights to RF front end 204 and/or control operational parameters of the RFID reader according to the schedule developed by server 203. Antenna weights and/or other operational parameters are changed periodically depending upon a current function of RFID reader 200.

Server 203 is provided to preferably receive data on tags identified by RFID reader 200. Server 203 preferably comprises a microprocessor controller that is programmed with a set of instructions to perform tasks taken from the group consisting of electronic article surveillance, point-of-sale operations, and inventory-management operations. In one embodiment of the present invention server 203 instructs (programs) scheduler 201 on what task to perform at what particular time. Scheduler 201 then appropriately operates RFID reader 200 and provides server 203 with the appropriate data.

Some functions performed by server 203 include, but are not limited to:
EAS Operations—The RFID reader functioning in this mode will scan an exit to the premise in order to determine if an item leaves the premise without being paid for.
Point-of-Sale Operations—The RFID reader functioning in this mode will scan a point-of-sale (e.g., a checkout counter) and provide pricing information to a user.
Inventory Management Operations—The RFID reader functioning in this mode will scan store shelves in order to determine if items are missing and need to be restocked. This mode may also be used to determine what inventory remains within the premises.
The RFID reader may function to detect tagged items that are moving from a backroom to a sales floor.

When performing these tasks antenna weights and/or operational modes may be changed depending upon which task is being performed. As discussed, each operational mode requires the use of certain operational parameters. The operational parameters include, but are not limited to:
a power level used by RF front end for transmitting an interrogation signal; and
a transmit data rate used between the RFID tag and reader RF front end.

As shown, reader 200 also includes antennas 202, a receiver and transmitter portion 220 (also referred to as transceiver 220), a baseband processor 212, and a network interface 216. These components of reader 200 may include software, hardware, and/or firmware, or any combination thereof, for performing their functions.

Baseband processor 212 and network interface 216 are optionally present in reader 200. Baseband processor 212 may be located remote from reader 200. For example, in an embodiment, network interface 216 may be present in reader 200, to communicate between transceiver portion 220 and a remote server that includes baseband processor 212. When baseband processor 212 is present in reader 200, network interface 216 may be optionally present to communicate between baseband processor 212 and a remote server. In another embodiment, network interface 216 is not present in reader 200. Processor 212 also processes computer readable program code components stored in a memory (not shown) of the reader 200 to implement various methods and functions of the reader 200 as described herein.

In an embodiment, reader 200 includes network interface 216 to interface reader 200 with a communications network 218. As shown in FIG. 3, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver portion 220 transmits the interrogation request via weighted antennas 202.

Reader 200 includes antennas 202 for communicating with tags 110 and/or other readers 200. The antennas 202 may be any type of reader antenna known to persons skilled in the relevant art, including a vertical, dipole, loop, Yagi-Uda, slot, or patch antenna type. Irrespective of the antenna type, each antenna is weighted in amplitude and phase to provide a desired resultant antenna pattern.

Transceiver 220 receives a tag response via antennas 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In some embodiments, network interface 216 enables a wired and/or wireless connection with communications network 218. For example, network interface 216 may enable a fixed local area network, or a wireless local area network (WLAN) link, including an Institute of Electrical and Electronics Engineers (IEEE) 802.11 WLAN standard link, a BLUETOOTH (Registered Trademark) link, and/or other types of wireless communication links. Communications network 218 may be a local area network (LAN), a wide area network (WAN) (e.g. the Internet), and/or a personal area network (PAN).

In various embodiments, a variety of mechanisms may be used to initiate an interrogation request by reader 200. For example, an interrogation request may be initiated by a remote computer system/server that communicates with reader 200 over communications network 218. Alternatively, reader 200 may include a keyboard and/or a graphical user interface (GUI) with which a user of reader 200 may interact to initiate an interrogation by reader 200.

In the example of FIG. 3, transceiver portion 220 includes RF front-end 204, a demodulator/decoder 206, and a modulator/encoder 208. These components of transceiver 220 may include software, hardware, and/or firmware, or any combination thereof, for performing their functions. An example description of these components is provided as follows.

Modulator/encoder 208 receives interrogation request 210, and is coupled to an input of RF front-end 204. Modulator/encoder 208 encodes interrogation request 210 into a signal format, modulates the encoded signal, and outputs the modulated encoded interrogation signal to RF front-end 204. For example, pulse-interval encoding (PIE) may be used in a Gen 2 embodiment. Furthermore, double sideband amplitude shift keying (DSB-ASK), single sideband amplitude shift keying (SSB-ASK), or phase-reversal amplitude shift keying (PR-ASK) modulation schemes may be used in a Gen 2 embodiment. Note that in an embodiment, baseband processor 212 may alternatively perform the encoding function of modulator/encoder 208.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FM0 or Miller encoding formats in an EPC Gen 2 embodiment. Demodulator/decoder 206 outputs decoded data signal 214. Note that in an embodiment, baseband processor 212 may alternatively perform the decoding function of demodulator/decoder 206.

The configuration of transceiver 220 shown in FIG. 3 is provided for purposes of illustration, and is not intended to be limiting. Transceiver 220 may be configured in numerous ways to modulate, transmit, receive, and demodulate RFID communication signals, as is known to persons skilled in the relevant art(s).

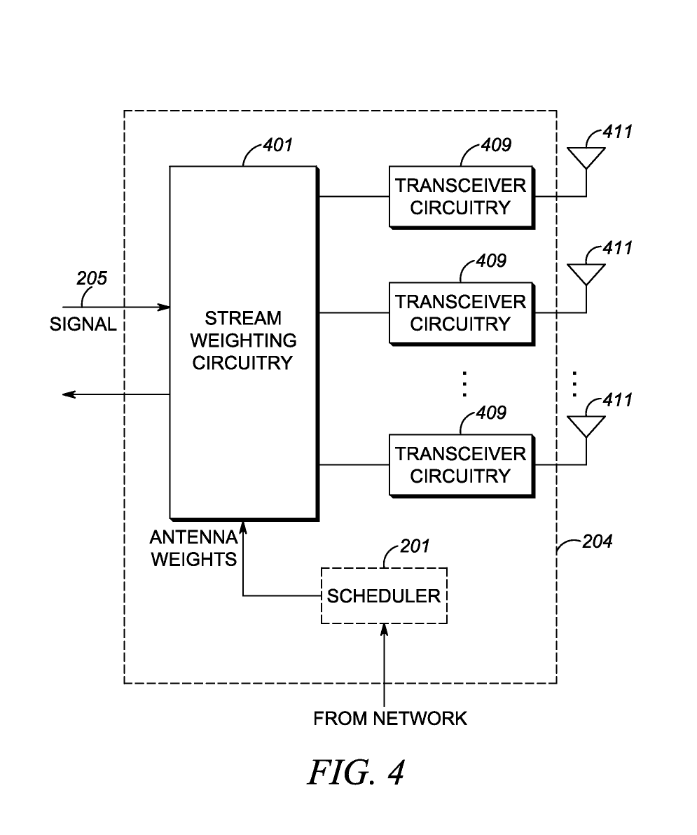

FIG. 4 is a block diagram of RF front end 204 shown with optional scheduler 201. RF front end 204 comprises stream weighting circuitry 401 and transceiver circuitry 409. During operation signal 205 to be transmitted enters stream weighting circuitry 401. Note that the weighting operation performed by stream weighting circuitry 401 will be performed for each of the carrier waves to be transmitted. Stream weighting circuitry 401 outputs a plurality of weighted streams, and in particular, one weighted stream per antenna. Each stream is appropriately weighted by an antenna-specific weight, to create a weighted stream for each of the transmit antennas (alternatively referred to as “antenna stream”). The weights are chosen to allow beam forming as described below.

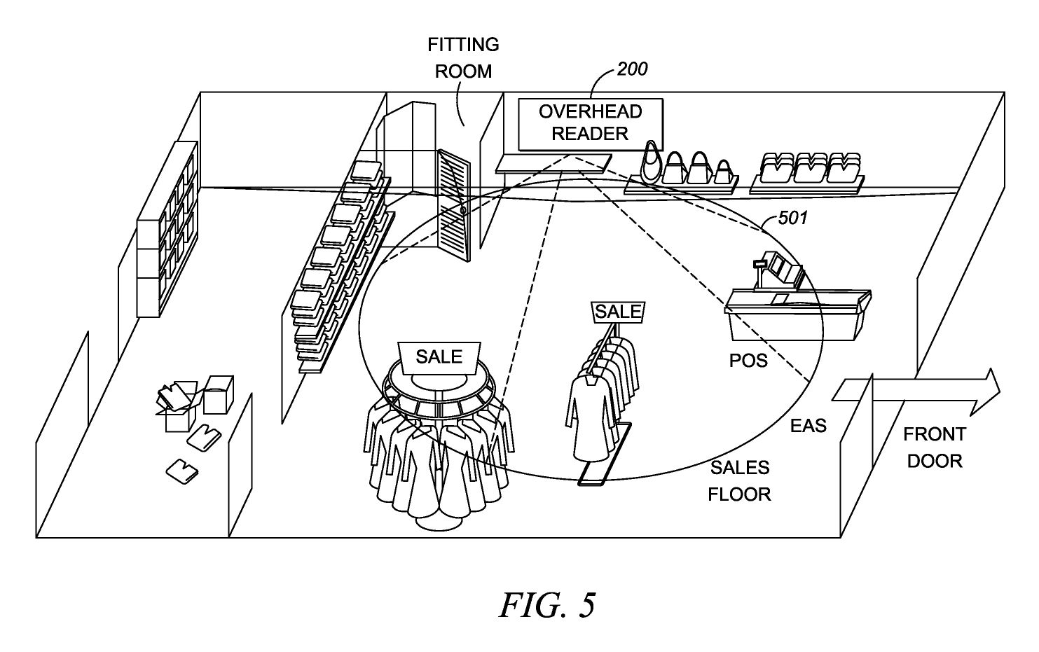

FIG. 5 illustrates RFID reader 200 employed within a premise scanning a first area with a first antenna pattern 501 and performing a first task using a first operational mode. When RFID reader 200 utilizes first antenna pattern 501, antenna pattern 501 is pointed in a first direction. Additionally, when utilizing first antenna pattern 501 pointed in the first direction, RFID scanner may perform a first task, such as inventory control. Additionally, first operational parameters may be utilized when performing the first task.

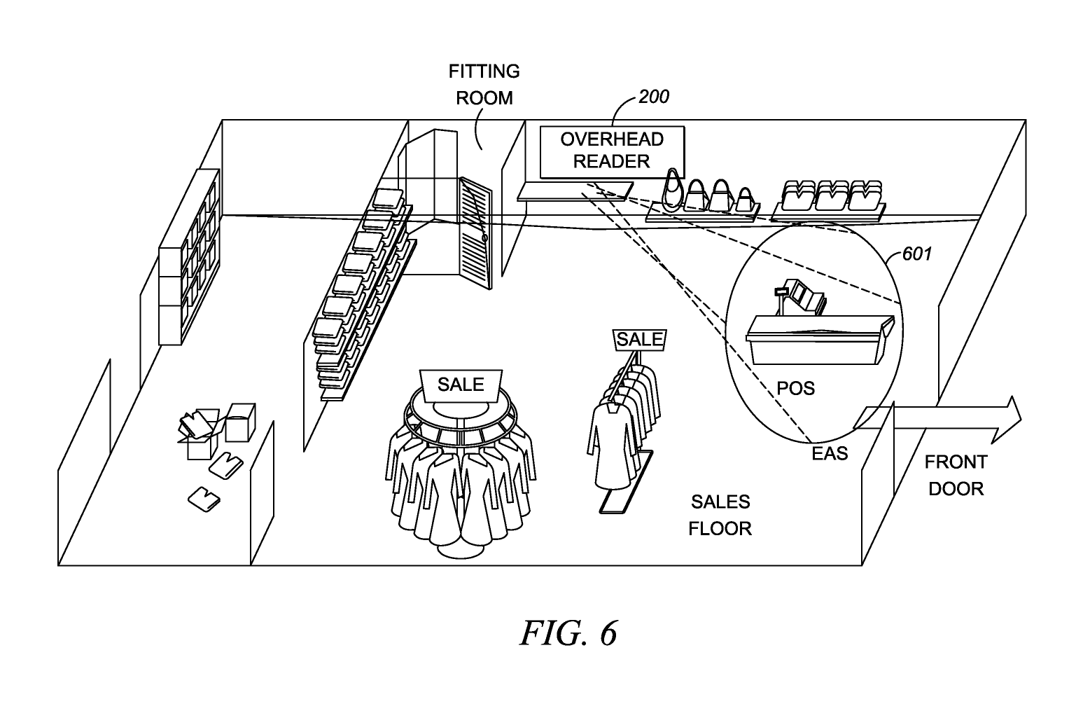

FIG. 6 illustrates RFID reader 200 employed within a premise scanning a second area with a second antenna pattern 601 using a second operational mode. When RFID reader 200 utilizes second antenna pattern 601, antenna pattern 601 is pointed in a second direction. Additionally, when utilizing second antenna pattern 601 pointed in the second direction, RFID scanner may perform a second task, such as performing point-of-sale (POS) checkout tasks, and may deploy an operational mode that differs from the mode utilized during the first task using antenna pattern 501. Additionally, second operational parameters may be utilized when performing the second task.

It should be noted that when RFID reader 200 is pointed in a first direction or a second direction, the “pointing” is accomplished via the utilization of appropriate antenna weights and is not accomplished simply by a user of the RFID reader physically moving RFID reader 200 in different directions.

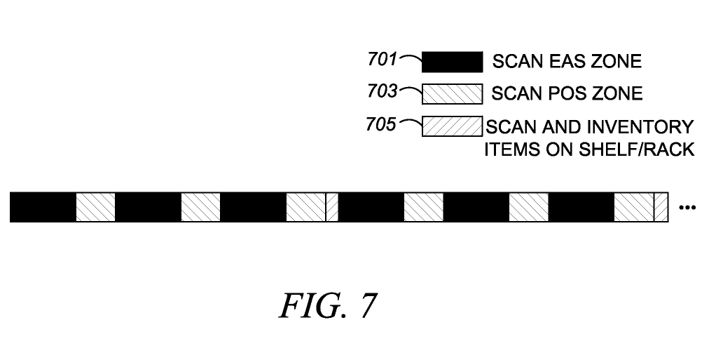

FIG. 7 shows the time-varying nature of the RFID reader of FIG. 5 and FIG. 6, illustrating how single physical reader 200 may divide its time in such a way to provide many distinct types of tasks. Different antenna patterns (beamforming) and operational modes may or may not be used for different tasks. In other words, each task may require a different antenna pattern, however in alternate embodiments, a single antenna pattern may be used as an RFID reader cycles through tasks. During each time period 701-705, reader 200 may be programmed to scan using one or multiple beams, for various amounts of time, with antenna weights and an operational mode suited ideally for the function being performed. As an example, FIG. 7 shows a possible scanning scenario that provides for performing EAS operations during a first time period 701. Also shown is the scanning of a point-of-sale (POS) zone at time period 703 when reader 200 will perform POS functionality. Finally, FIG. 7 shows the scanning of items on a shelf/rack at time period 705 during an inventory tracking task. As mentioned above, during each time period specific operational mode and antenna weights may be utilized by reader 200 to achieve a desired antenna pattern pointed in a desired direction with operational parameters most suited for the task associated with each time slot.

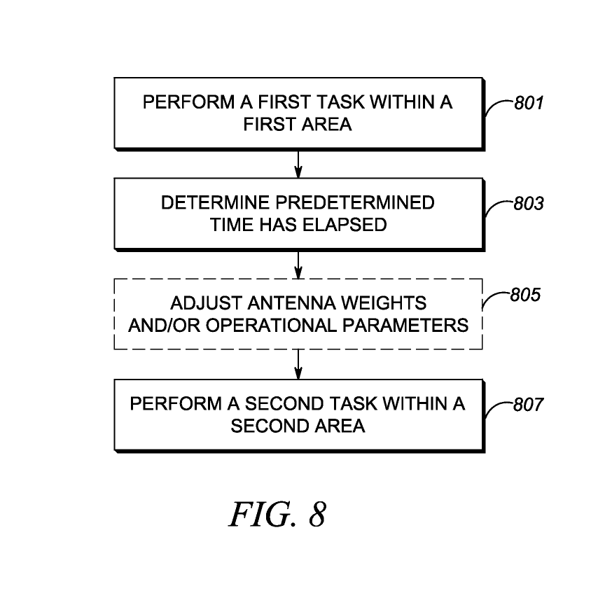

FIG. 8 is a flow chart showing operation of the RFID reader in FIG. 5 and FIG. 6. The logic flow begins at step 801 where scheduler 201 operates the RFID reader to perform a first task within a first area. As discussed above, this step may comprise utilizing first antenna weights and operating using a first mode of operation when performing the first task within the first area. At step 803 scheduler 201 then determines that a predetermined period of time has elapsed and in response, may perform the optional step 805 of adjusting antenna weights and/or operational parameters in response to the determination that the predetermined period of time has elapsed. Regardless of whether or not antenna weights or operational parameters have been adjusted, at step 807 scheduler 201 operates the RFID reader to perform a second task within a second area. This step may optionally be done using the adjusted antenna weights and/or operational parameters.

When using different antenna weights to perform different tasks, the first area may be scanned with a first antenna pattern and the second area may be scanned with a second antenna pattern. Additionally, the first area may be scanned along a first direction with the first antenna pattern and the second area may be scanned along a second direction with the second antenna pattern. The direction of scanning is dependent upon the antenna weights being utilized.

When using different operational parameters to perform different tasks, the first area may be scanned with a first operational parameter (e.g., RF Front End Power) and the second area may be scanned with a second operational parameter.

Although the above description was given with a single RFID reader changing antenna weights to scan different areas and perform different tasks, it should be noted that the above description may be extended to the use of multiple RFID readers changing antenna weights to scan different areas and perform different tasks simultaneously. For example, there may exist two RFID readers performing a first task, with one RFID reader changing antenna weights and performing a different task during a second time period.

In the foregoing specification, specific embodiments have been described. However, one of ordinary skill in the art appreciates that various modifications and changes can be made without departing from the scope of the invention as set forth in the claims below. For example, the scheduler is described as scheduling RFID readers based on time. However, it could very well decide to move between areas based on different criteria. For instance, an RFID reader might stop doing inventory scanning if it is not detecting any new tags. In another embodiment, the RFID reader might be pre-empted to do EAS because a motion detector near a door detected an item is passing near. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for operating an RFID reader, the method comprising the steps of:
operating the RFID reader to perform a first task within a first area;
the RFID reader determining that predetermined period of time has elapsed; and
operating the RFID reader to perform a second task within a second area.

2. The method of claim 1:
wherein the step of operating the RFID reader to perform the first task within a first area comprises the step of operating the RFID reader utilizing first antenna weights to perform the first task within the first area;
and further comprising the step of the RFID reader adjusting antenna weights in response to the determination that a predetermined period of time has elapsed; and
wherein the step of operating the RFID reader to perform the second task within the second area comprises the step using the adjusted antenna weights to perform using the second task within the second area.

3. The method of claim 1:
wherein the step of operating the RFID reader to perform the first task within a first area comprises the step of operating the RFID reader utilizing first operational parameter to perform the first task within the first area;
and further comprising the step of the RFID reader adjusting the operational parameter in response to the determination that a predetermined period of time has elapsed; and
wherein the step of operating the RFID reader to perform the second task within the second area comprises the step using the adjusted operational parameter to perform using the second task within the second area.

4. The method of claim 3 wherein the first area is scanned with a first antenna pattern and the second area is scanned with a second antenna pattern.

5. The method of claim 3 wherein the first area is scanned along a first direction with a first antenna pattern and the second area is scanned along a second direction with a second antenna pattern.

6. The method of claim 1 wherein the first task and the second task are taken from the group consisting of electronic article surveillance, point-of-sale operations, and inventory-management operations.

7. A method for operating an RFID reader, the method comprising the steps of:
operating the RFID reader utilizing first antenna weights to perform a first task within a first area;
the RFID reader determining that predetermined period of time has elapsed;
the RFID reader adjusting antenna weights in response to the determination that a predetermined period of time has elapsed; and
operating the RFID reader to perform a second task within a second area using the adjusted antenna weights.

8. The method of claim 7 wherein the RFID reader also adjusts operational parameters in response to the determination that the predetermined period of time has elapsed.

9. The method of claim 7 wherein the first area is scanned with a first antenna pattern and the second area is scanned with a second antenna pattern.

10. The method of claim 7 wherein the first area is scanned along a first direction with a first antenna pattern and the second area is scanned along a second direction with a second antenna pattern.

11. An RFID system comprising:
a scheduler operating the RFID reader to perform a first task within a first area;
the scheduler determining that predetermined period of time has elapsed; and
the scheduler operating the RFID reader to perform a second task within a second area.

12. The RFID system of claim 11:
wherein operating the RFID reader to perform the first task within a first area comprises operating the RFID reader utilizing first antenna weights to perform the first task within the first area;
wherein the scheduler adjusts antenna weights in response to the determination that a predetermined period of time has elapsed; and
wherein operating the RFID reader to perform the second task within the second area comprises using the adjusted antenna weights to perform using the second task within the second area.

13. The RFID system of claim 12 wherein the first area is scanned with a first antenna pattern and the second area is scanned with a second antenna pattern.

14. The RFID system of claim 12 wherein the first area is scanned along a first direction with a first antenna pattern and the second area is scanned along a second direction with a second antenna pattern.

15. The RFID system of claim 12 wherein the first task and the second task are taken from the group consisting of electronic article surveillance, point-of-sale operations, and inventory-management operations.

16. The RFID system of claim 11:
wherein operating the RFID reader to perform the first task within a first area comprises operating the RFID reader utilizing operating mode to perform the first task within the first area;
wherein the scheduler adjusts the operating mode in response to the determination that a predetermined period of time has elapsed; and
wherein operating the RFID reader to perform the second task within the second area comprises using the adjusted operating mode to perform using the second task within the second area.

17. The system of claim 16 wherein the operating mode is taken from the group consisting of a power level and a data rate.
